(19) United States
(12) Patent Application Publication
(10) Pub. No.: US 2015/0100441 A1
(43) Pub. Date: Apr. 9, 2015

(54) RETAIL ENGINE FOR ELECTRONIC SMOKING DEVICE

(71) Applicant: LOEC, Inc., Greensboro, NC (US)

(72) Inventors: Ramon Alarcon, Los Gatos, CA (US); Christopher Kepner, Campbell, CA (US)

(21) Appl. No.: 14/507,685

(22) Filed: Oct. 6, 2014

Related U.S. Application Data
(60) Provisional application No. 61/887,065, filed on Oct. 4, 2013.

(51) Int. Cl. G06Q 20/18; G06Q 30/06; G06Q 20/20

(52) U.S. Cl. CPC G06Q 20/18; G06Q 20/20; G06Q 30/06
USPC 705/16

(57) ABSTRACT

A retail system for electronic cigarettes includes a point-of-sale device configured to communicate with an electronic cigarette user, an electronic cigarette, an electronic cigarette charging pack, a mobile phone, and/or a vendor of electronic cigarettes.

### CROSS REFERENCE TO RELATED APPLICATION

This application claims the benefit of U.S. provisional application No. 61/887,065, tiled 4 Oct. 2013. which is hereby incorporated by reference as though fully set forth herein.

### FIELD OF THE DISCLOSURE

The present disclosure relates to a system, a method, and a device for retailing electronic articles, and more particularly for retailing electronic cigarettes.

### BACKGROUND OF THE DISCLOSURE

Electronic cigarettes, also known as e-cigarettes (eCigs) and personal vaporizers (PVs), are a popular alternative to traditional tobacco-based cigarettes that must be burned in order to generate smoke for inhalation. Electronic cigarettes provide a vapor for inhalation, but do not contain certain byproducts of combustion that may be harmful to human health. Electronic cigarettes are electronic inhalers that vaporize or atomize a liquid solution (smoke juice) into an aerosol mist that may then be delivered to a user. A typical eCig has two main parts—a battery part and a cartomizer. The battery part typically includes a rechargeable lithium-ion (Li-ion) battery, a light emitting diode (LED), and a pressure sensor. The cartomizer typically includes a liquid solution, an atomizer, and a mouthpiece. The atomizer typically includes a heating coil that vaporizes the liquid solution.

### SUMMARY OF THE DISCLOSURE

According to an aspect of the disclosure, a retail system for electronic cigarettes includes a point-of-sale device configured to communicate with an electronic cigarette user, an electronic cigarette, an electronic cigarette charging pack, a mobile phone, and/or a vendor of electronic cigarettes.

In one embodiment, a retail system for an electronic smoking device comprises a charging pack configured to hold or charge the electronic smoking device; and a point-of-sale device configured to facilitate sales of at least one of the charging pack or the electronic smoking device; wherein one of the charging pack or the point-of-sale device is configured to broadcast a radiofrequency communication; and wherein the other of the charging pack or the point-of-sale device is configured to receive the radiofrequency communication.

In another embodiment, a retail system for an electronic smoking device comprises the electronic smoking device; and a point-of-sale device configured to facilitate sales of the electronic smoking device; wherein one of the electronic smoking device or the point-of-sale device is configured to broadcast a radiofrequency communication; and wherein the other of the electronic smoking device or the point-of-sale device is configured to receive the radiofrequency communication.

In another embodiment, a method of retailing an electronic smoking device comprises collecting at least one of the following types of data: i) electronic-smoking-device data received from the electronic smoking device, ii) pack data received from a charging pack configured to hold or charge the electronic smoking device, iii) point-of-sale data received from a point-of-sale device configured to facilitate sales of at least one of the charging pack or the electronic smoking device, or iv) smart-phone data received from a smart phone configured to communicate with at least one of the pack or the point-of-sales device; selecting a retail signal had on the collected data, and displaying the retail signal on at least one of the electronic smoking device, the charging pack, the point-of-sale device, the smart phone, or a vendor program.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may he necessary for a fundamental understanding of the disclosure and the various ways in which it may he practiced. In the drawings:

FIG. 1A shows an example of an electronic article that is constructed according to an aspect of the disclosure.

FIG. 1B shows another example of an electronic article that is constructed according to an aspect of the disclosure.

FIG. 2 shows an example of a charging holder that is constructed according to an aspect of the disclosure.

FIG. 3 shows an example of a conceptual overview of a system for retailing electronic articles.

FIG. 4 shows another embodiment of a system for retailing electronic articles.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following. It should be noted that the features illustrated in the drawings are not necessarily drawn to scale, and features of one embodiment may be employed with other embodiments as the skilled artisan would recognize, even if not explicitly stated herein, Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

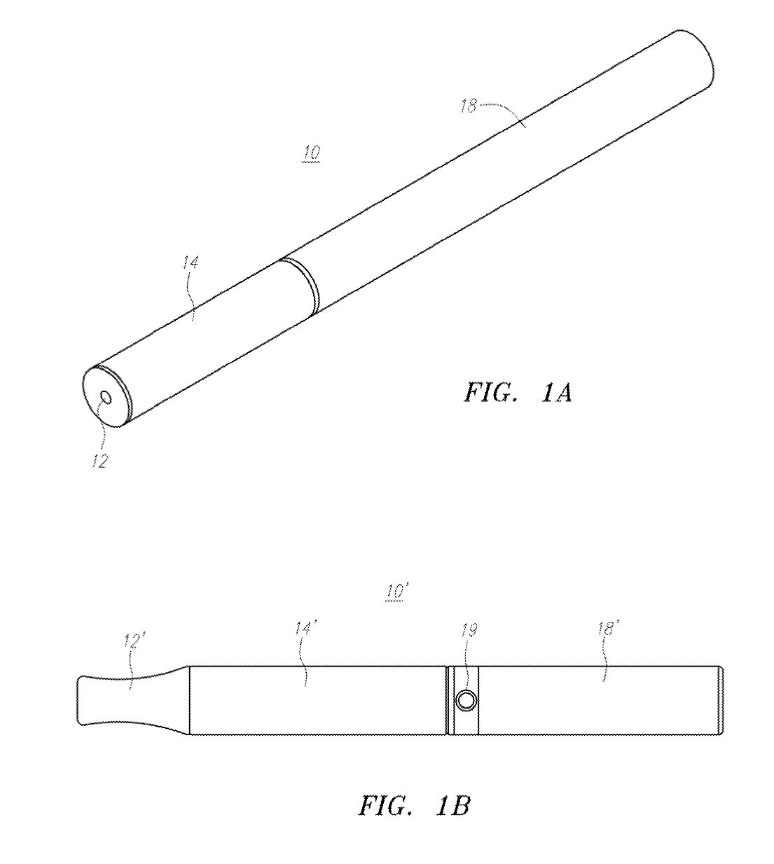

FIG. 1A shows an example of an electronic article 10 according to an aspect of the disclosure. In the instant example, the electronic article 10 comprises an electronic smoking device, namely, an eCig. However, the electronic article 10 may comprise any article that may be charged by an external power supply, such as, e.g., a rechargeable battery, or the like.

The eCig 10 comprises a cartridge 14 and an eCig body 18. The cartridge 14 comprises an opening 12 through which aerosol may be delivered to a user. The cartridge 14 comprises a solution (not shown) and an atomizer (not shown). The solution may include, e.g., a liquid, a gel, a solid, or a gas that comprises molecules (or particles) to he delivered in an aerosol to a user. The eCig body 18 includes a power supply (e.g., a rechargeable Li-ion battery) (not shown) and an LET) (not shown). In an alternative embodiment, the cartridge 14 and the eCig body 18 can be combined into a single unit.

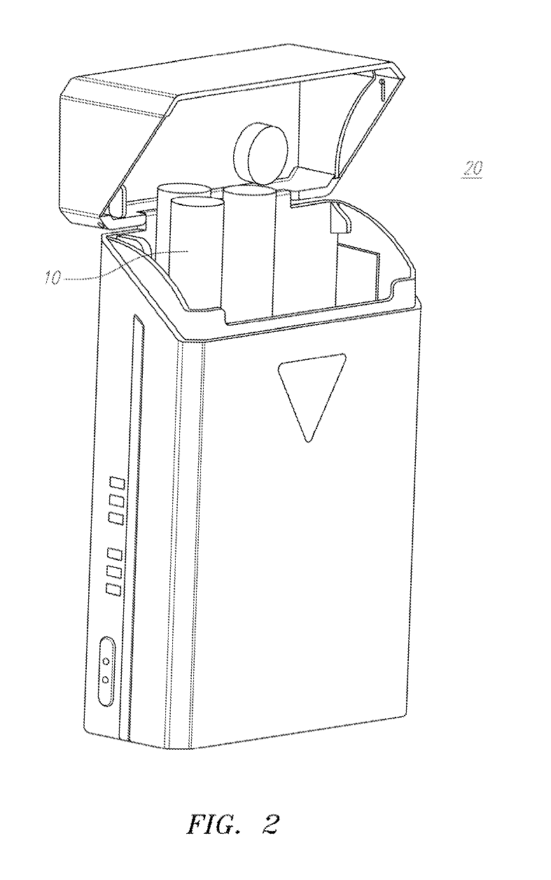

FIG. 1B shows another example of an electronic article 10′ according to an aspect of the disclosure. In this example, the electronic article 10′ comprises an eCig. The eCig 10′ comprises a refillable cartridge 14′ and an eCig body 18′. The cartridge 14′ includes a mouthpiece 12′ through which aerosol may be delivered to a user. The cartridge 14′ comprises a solution (not shown) and an atomizer not shown). The solution may include, e.g., a liquid, a gel, a solid, or a gas that comprises molecules (or particles) to be delivered in an aerosol to a user. Notably, the cartridge 14′ can be refilled with the solution. The eCig body 18′ includes a power supply (e.g., a rechargeable Li-ion battery) (not shown) and an LED (not shown). In addition, the eCig body 18′ can include an activation button 19 that a user can press to activate the eCig 10′. FIG. 2 shows an example of a charging holder (pack) 20. The charging holder 20 in this example comprises a eCig charging pack. The pack 20 comprises one or more regions that are configured to receive the eCig body 18, and/or the cartridge 14, and/or the entire eCig 10. In the example illustrated in FIG. 2, the pack 20 comprises a plurality of regions, each of which is configured to receive a respective eCig 10, or a component of the eCig 10 (e.g., cartridge 14 and/or eCig body 18). The pack 20 comprises a charging device that connects to and supplies a power source to charge the power supply (e.g., Li-ion battery) in the eCig 10, or a component of the eCig 10 cartridge 14 and/or eCig body 18).

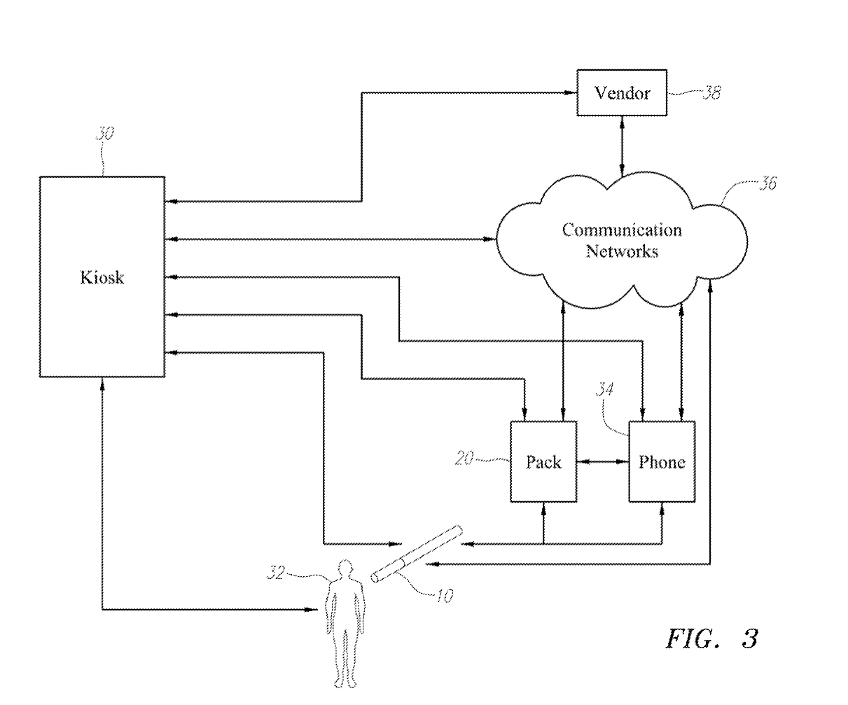

FIG. 3 shows an example of a retail system for eCigs. One embodiment involves a kiosk 30, which serves as a point-of-sale device. The kiosk 30 can include a cardboard cutout (e.g., in the shape or an eCig 10 or pack. 20) with a display rack. The kiosk 30 can include a transceiver, capable of receiving and transmitting data related to eCig use or sales. The kiosk 30 can also include a microprocessor and local memory. In an example, the kiosk 30 can be located in a mall or store. The kiosk 30 can also be a stand-alone retail engine, such as on a sidewalk or other outdoor area.

The kiosk 10 can communicate directly with a user 12 who is passing by. For example, the kiosk 30 can use verbal, visual, olfactory, or other sensory stimulants or methods of advertising to elicit a user's attention. In an example, the user 32 can communicate interactively with the kiosk 30 via a user interface, such as a computer (not shown). In other instances, the kiosk 10 can communicate with a user's smart phone 34, either directly or via the user's pack 20 or eCig 10. For example, the smart phone 34 could route a command to the kiosk 30 to light up, make noise, or take some other action to make the kiosk 30 more visible to the user 32. In another example, the kiosk 30 can communicate with the user's pack 20 or eCig 10 and cause the pack 20 or eCig 10 vibrate or make a sound, such as in response to a kiosk beacon. In the alternative, the pack 20 or eCig 10 can cause the kiosk 30 to vibrate, make a sound, or light up. In this case, the beacon can be located in the pack 20 or the eCig 10.

The kiosk 30 can also communicate with the user's eCig pack 20, eCig 10, or smart phone 34 through communication networks 36 (e.g., server-based network, LAN, WAN, Internet, intranet, Wi-Fi network, Bluetooth network, cellular network and/or the like). GPS data or other location-based services data (e.g., cellular triangulation or IP address) can also be included in the communication networks 36 and can be used to facilitate communication between the kiosk 30 and the user's pack 20, eCig 10, or smart phone 34. For example, the kiosk 30 can send coupons, promotions, or alerts to the user 32 via the user's phone 34, pack 20, or eCig 10, potentially in response to data communicated from the phone 34, the pack 20, or the eCig 10 to the kiosk 30 (e.g., user is low on cartridges, smoke juice, battery life of pack, and/or the like). The phone 34 can collect inventory and usage information from the pack 20 or eCig 10 and send this information to the communication networks 36 (e.g., server-based network, LAN, WAN, Internet, intranet, Wi-Fi network, Bluetooth network, cellular network and/or the like), which in turn can determine, whether the kiosk 30 has what the user 32 needs. If the kiosk 30 contains what the user 32 needs, the communication networks 36 can send an alert or coupon to the phone 34. Additionally, the phone 34 can be configured to trigger an electronic purchase (or credit or other financial transaction) from a user's mobile wallet (e.g., Google Wallet or Apple Pay), in response to information from the kiosk 30, pack 20, or eCig 10 regarding inventory, pricing, or marketing. Other devices that can be used instead of or in addition to the smart phone 34 include a mobile phone (not shown), a personal data assistant (PDA) (not shown), a tablet PC (not shown) and/or the like.

In another example, kiosk inventory, pricing, or marketing information can be pre-installed or downloaded into the kiosk 30. The kiosk 30 can broadcast such information to the pack 20, eCig 10, and/or phone 34. The phone 34 can then use this kiosk information, together with any inventory and usage information that it has collected from the pack 20 or eCig 10, to determine whether to display an alert, coupon, purchase option, or the like to the user 32. The kiosk 30 can he linked directly to communication networks 36. For example, the kiosk 30 can be connected to the Internet via a Wi-Fi network. Information collected from the kiosk 30 can then be communicated, either directly or via communication networks 36, to a vendor 38. For example, the kiosk 30 can manage inventory, such as by tracking RFID tags (either contained within the pack 20, the eCig 10, or the packaging of any component thereof, or on separately-sold items such as liquid refill bottles or replacement cartridges), and alert the vendor 38 when inventory is low. Alternatively, the kiosk 30 can manage inventory via a pressure sensor or series of switches (not shown) located within the kiosk 30. The pressure sensor or series of switches can be configured to signal when a particular product has been purchased from, and therefore exits, the kiosk 30. Information regarding inventory received from the pressure sensor or series of switches can be communicated via communication networks 36 from the kiosk 30 to the vendor 38.

In addition, the kiosk 30 can self-order more eCigs or packs for its display rack by communicating with the vendor 38 or communication networks 36. In an example, the kiosk 30 can determine when an eCig 10 or pack 20 has been on the rack too long (e.g., battery life is depleted, smoke juice or cartridge is too old, expiration date has passed, and/or the like), and remove or disable the eCig 10 or pack 20. Similarly, the kiosk 30 can alert the vendor 38 (e.g., directly or via communication networks 36) to remove or replace expired inventory from the kiosk 30, as well as update any records of the kiosk's inventory. In another example, the kiosk 30 can track information about kiosk inventory levels and/or sales that resulted from purchase coupons sent to users in proximity to the kiosk 30, and this information can then be communicated via communication channels 36 to marketing or inventory-tracking personnel associated with the vendor 38.

One embodiment of the retail system shown in FIG. 3 involves using the user pack 20 or eCig 10 to communicate via communication networks 36 with the vendor 38. For example the pack 20 or eCig 10 may have a screen or other user interface capable of receiving coupons or other advertisements. The vendor 38 can use one or more computers (not shown) (e.g., a desktop PC, a laptop PC, a mobile phone a personal data assistant (PDA), a tablet PC and/or the like) that are connected to the pack 20 or eCig 10 via various wired and/or wireless communication networks 36 to send coupons to the pack's or eCig's screen. As discussed above, GPS data or other location-based services data (e.g., cellular triangulation or IP address) can also be used to facilitate communication between the user's pack 20 or eCig 10 and the vendor 38. For example, the user's pack 20 or eCig 10 may alert the vendor 38 when the user 32 passes by. In response, the vendor 38 may send a coupon or other advertisement to the pack 20 or eCig 10.

In an embodiment, radio frequency (RF) communications, such as Bluetooth Low Energy (BEE) communications, for example can be used to generate alerts to the vendor 38 or the user 32. For example, the kiosk 30, pack 20, eCig 10, or phone 34 can contain a Bluetooth chip and can periodically transmit a BLE beacon. The beacon can trigger a data exchange when the user's pack 20, eCig 10, or phone 34 come into proximity with the kiosk 30. Data can be sent from the kiosk 30 directly to the phone 34, or to the phone 34 via the pack 20 or eCig 10. After the data exchange is initiated, the phone 34, pack 20, or eCig 10 can collect data from the kiosk 30 and send the data to the communication network 36. The communication network 36 can then use a combination of the pack data, the eCig data, the phone data, and the kiosk, data to determine whether to send out a coupon, rebate, marketing alert, or other advertising or retail information to the user's phone 34, pack 20, or eCig 10, or to the vendor 38.

Furthermore, the RI communication or beacon can broadcast a message of any type, including information regarding en advertisement, deal, offer, coupon, the location of the vendor, the inventory of the vendor, or the name of the vendor, for example. The message can be received by the user's pack 20 or phone 34 or ecig 10. In response to the broadcast, when the user's pack 20 or phone 34 or ecig 10 are within range of the beacon, the user's pack 20 or phone 34 or ecig 10 can produce an alert, notification, or display message (e.g., a visual, auditory, olfactory, or haptic display) conveying portions of the information contained in the broadcast. In another example, the beacon may also include radio signal strength indicator (RSSI) information. This information may be used by the user's pack 20 or phone 34 or ecig 10 to estimate the proximity to the kiosk 30 by analyzing the received signal strength and the RSSI information. As the user's pack 20 or phone 34 or ecig 10 increases or decreases in proximity to the kiosk 30, the user's pack 20 or phone 34 or ecig 10 may generate a notice, message or alert that corresponds to the degree of proximity. In another example, the broadcast message can be a rebate or coupon sent to the vendor 38, which the vendor 38 can the offer to the user 32.

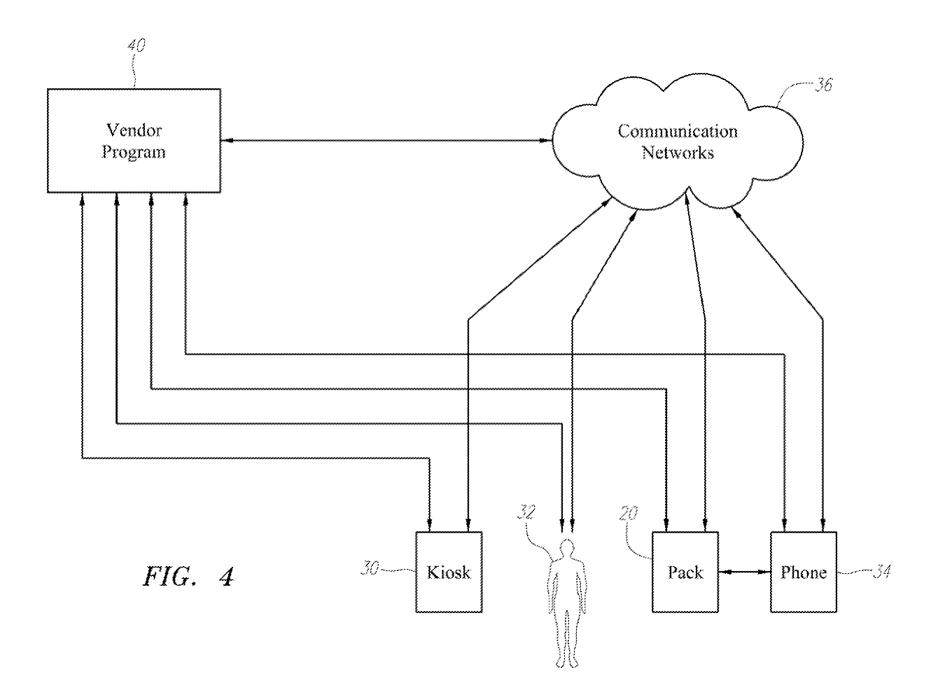

Another embodiment of a retail system is shown in FIG. 4. This embodiment involves a vendor program 40 (e.g., a computer program or smart phone application) that can receive and store data from various sources, including a kiosk 30, a user 32, a pack 20, an eCig 10, or a phone 34. In an example, the vendor program 40 can be resident on the pack 20, the eCig 10, or the phone 34. The vendor program 40 can receive data directly from the kiosk 30, the user 32, the pack 20, the eCig 10, or the phone 34, or indirectly via communication networks 36. GPS data or other location-based services data (e.g., cellular triangulation or IP address) indicating the location of the kiosk 30, the user 32, the pack 20, the eCig 10, or the phone 34, can also be received and stored by the vendor program 40.

Exemplary data that can be received and stored by the vendor program 40 includes a user profile containing information such as: pack barcode, pack serial number, pack age (e.g., time elapsed since date of manufacture), batters life of pack (e.g., amount of battery life remaining) eCig serial number, eCig battery usage, eCig battery life, number of cartridges remaining, smoke juice level of eCigs, smoke juice flavors used, location of user, location of user while puffing, number of puffs taken (e.g., total number or number per hour), length of puffs (e.g., in seconds), general population demographics of the area where the kiosk 30 or user 32 is located, and/or the like. In some instances, the vendor program 40 can receive data that has first been communicated from the eCig 10 to the pack 20.

In addition to receiving and storing such data the vendor program 40 can use the data to send coupons or marketing materials to the kiosk 30 (or a store, not shown), the user 32, the pack 20, the eCig 10, and/or the phone 34. For example, when the vendor program 40 receives data indicating that the user 32 is low on cartridges, the vendor program 40 can e-mail a coupon for cartridges to the user 32 or send marketing materials to a store or kiosk near the user 32. In another example, when the vendor program 40 receives data indicating that a new flavor has been launched in a particular region, the vendor program 40 can send coupons directly to packs or eCigs sold or currently located in that area, directly to mobile devices associated with packs or eCigs sold or currently located in the area, or indirectly to a user's mobile phone (via the purchased pack or eCig). The vendor program 40 can identify these packs or eCigs using BLE beacon information or RFID tags, for example. The coupons can be displayed on the user's mobile phone or pack screen or eCig screen. In this way, the new flavor can market itself. In another embodiment, a separate database can be used to store data received by the vendor program 40. This database can reside on one or more network computers or servers, for example. Thus, data received by the vendor program 40 can be stored locally (i.e., in the vendor program 40), in a network environment (i.e. in the database), or in both locations.

A “computer,” as used in this disclosure, means any machine, device, circuit, component, or module, or any system of machines, devices, circuits, components, modules, or the like, which are capable of manipulating data according to one or more instructions, such as for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing, units, general purpose computers, super computers, personal computers, laptop computers, palmtop computers, notebook computers, desktop computers, workstation computers, servers, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from, clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The wired medium may include a power supply line. The RF communication link may include, for example, WiFi, WiMAX, IEEE 802.11, DECT, (XL 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), as broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HUP.

The terms “including “comprising” and variations thereof, as used in this disclosure, mean “including, but not limited to,” unless expressly specified otherwise.

The terms and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

While the disclosure has been described in terms of exemplary embodiments, those skilled in the art will recognize that the disclosure can be practiced with modifications that fall within the spirit and scope of the appended claims. These examples given above are merely illustrative and are not meant to be an exhaustive list of all possible designs, embodiments, applications or modification of the disclosure. In particular, it should be noted that all of the above-described capabilities of the eCig pack can also be attributed to the eCig itself.

Although embodiments of a retail engine for an electronic smoking device have been described above with a certain degree of particularity, those skilled in the art could make numerous alterations to the disclosed embodiments without departing from the spirit or scope of this disclosure. All directional references (e.g., upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the devices. Joinder references (e.g., affixed, attached, coupled, connected, and the like) are to be construed broadly and can include intermediate members between a connection of elements and relative movement between elements. As such, joinder references do not necessarily infer that two elements are directly connected and in fixed relationship to each other. It is intended that all matter contained in the above description or shown in the accompanying drawings shall be interpreted as illustrative only and not limiting. Changes in detail or structure can be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Various embodiments have been described above to various apparatuses, systems, and/or methods. Numerous specific details have been set forth to provide a thorough understanding of the overall structure, function, manufacture, and use of the embodiments as described in the specification and illustrated in the accompanying drawings. It will be understood by those skilled in the art, however, that the embodiments ma be practiced without such specific details. In other instances, well-known operations, components, and elements have not been described in detail so as not to obscure the embodiments described in the specification. Those of ordinary skill in the art will understand that the embodiments described and illustrated above are non-limiting examples, and thus it can be appreciated that the specific structural and functional details disclosed above may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

What is claimed is:

1. A retail system for an electronic smoking device, the system comprising
a charging pack configured to hold or charge the electronic smoking device; and
a point-of-sale device configured to facilitate sales of at least one of the charging pack or the electronic smoking device;
wherein one of the charging pack or the point-of-sale device is configured to broadcast radiofrequency communication; and wherein the other of the chanting pack or the point-of-sale device is configured to receive the radio frequency communication.

2. The retail system of claim 1, wherein the radio frequency communication is a Bluetooth Low Energy beacon.

3. The retail system of claim 1, wherein the point-of-sale device further comprises at least one of a data transceiver, a microprocessor, and a local memory.

4. The retails system of claim 1, wherein the charging pack comprises pack data; wherein the point-of-sale device comprises point-of-sale data; wherein the charging pack configured to transmit the pack data via the radiofrequency communication to the point-of-sale device; and wherein the point-of-sale device is configured to transmit the point-of-sale data via the radiofrequency communication to the charging pack.

5. The retail system of claim 4, wherein the pack data comprises at least one of the following: a pack barcode, a pack serial number, a pack age, a battery life of the pack, a number of cartridges remaining in the pack, a smoke juice level of one or more electronic smoking devices stored within the pack, a flavor of smoke juice used in one or more electronic smoking devices stored within the pack, a location of a user of the pack, a number of puffs taken on one or more electronic smoking devices stored within the pack, and an average length of puffs taken on one or more electronic smoking devices stored within the pack.

6. The retail system of claim 4, wherein the point-of-sale data comprises at least one of the following: an inventory of the point-of-sale device, a length of time that the charging pack or the electronic smoking device has been on sale, and a sales history of the point-of-sale device.

7. The retail system of claim 4, further comprising
a smart phone configured to communicate with the charging pack or the point-of-sale device, the smart phone comprising smart-phone data; and
a communication network communicatively linked to the charging pack, the point-of-sale device, and the smart phone;
wherein the communication network is configured to determine a retail signal based on at least one of the pack data the point-of-sale data and the smart-phone data; and wherein the communication network is further configured to provide the retail signal to at least one of the electronic smoking device, the charging pack, the point-of-sale device, the smart phone, or a vendor program.

8. The retail system of claim 7, wherein the smart-phone data comprises at least one of the following: the pack data or a smart phone application related to the pack data.

9. The retail system of claim 7, wherein the communication network comprises at least one of a server-based network, a local-area network, a wide-area network, an Internet, an intranet, a Wi-Fi network, a Bluetooth network, a cellular network, or a location-based services network.

10. The retail system of claim 7, wherein the retail signal comprises at least one of the following: a coupon, a rebate, an advertisement, an offer, a deal, a name of a vendor, a location of the vendor, an inventory of the vendor, an electronic purchase order, or an electronic payment.

11. The retail system of claim 7, wherein the retail signal is configured to be displayed by at least one of the electronic smoking device, the charging pack, the point-of-sale device, or the smart phone.

12. The retail system of claim 11, wherein the retail signal is configured to be displayed via visual auditory, olfactory, or haptic means.

13. The retail system of claim 7, wherein the vendor program is configured to store or exchange data with at least one of the charging pack, the point-of-sale device, the smart phone, or the communication network.

14. The retail system of claim 7, wherein the vendor program is configured to provide the retail signal to at least one of the electronic smoking device, the charging pack, the point-of-sale device, or the smart phone.

15. The retail system of claim 7, wherein the vendor program comprises a computer program or a smart phone application.

16. A retail system for an electronic smoking device, the system comprising
the electronic smoking device; and
a point-of-sale device configured to facilitate sales of the electronic smoking device;
wherein one of the electronic smoking device or the point-of-sale device is configured to broadcast a radiofrequency communication; and wherein the other of the electronic smoking device or the point-of-sale device is configured to receive the radiofrequency communication.

17. The retail system of claim 16, wherein the radio frequency communication is a Bluetooth Low Energy beacon.

18. The retail system of claim 16, wherein the point-of-sale device further comprises at least one of a data transceiver, a microprocessor, and as local memory.

19. The retail system of claim 16, wherein the electronic smoking device comprises electronic-smoking-device data; wherein the point-of-sale device comprises point-of-sale data; wherein the electronic smoking device is configured to transmit the electronic-smoking-device data via the radiofrequency communication to the point-of-sale device; and wherein the point-of-sale device is configured to transmit the point-of-sale data via the radiofrequency communication to the electronic smoking device.

20. The retail system of claim 19, wherein the electronic-smoking-device data comprises at least one of the following: an electronic smoking device barcode, an electronic smoking device serial number, an electronic smoking, device age, a battery life of the electronic smoking device, a smoke juice level of the electronic smoking device, a flavor of smoke juice used in the electronic smoking device, a location of a user of the electronic smoking device, a number of puffs taken on the electronic smoking device, or an average length of puffs taken on the electronic smoking device.

21. The retail system of claim 19, wherein the point-of-sale data comprises at least one of the following: an inventory of the point-of-sale device, a length of time that the electronic smoking device has been on sale, and a sales history of the point-of-sale device.

22. The retail system of claim 19, further comprising
a smart phone configured to communicate with the electronic smoking device and the point-of-sale device, the smart phone comprising smart-phone data; and
a communication network communicatively linked to the electronic smoking device, the point-of-sale device, and the smart phone;
wherein the communication network is configured to determine a retail signal based on at least one of the electronic-smoking-device data, the point-of-sale data, and the smart-phone data; and wherein the communication network is further configured to provide the retail signal to at least one of the electronic smoking device, the point-of-sale device, the smart phone, or a vendor program.

23. The retail system of claim 22, wherein the smart-phone data comprises at least one of the following: the electronic-smoking-device data or a smart phone application related to the electronic-smoking-device data.

24. The retail system of claim 22, wherein the communication network comprises at least one of a server-based network, a local-area network, a wide-area network, an Internet, an intranet, a Wi-Fi network, a Bluetooth network, a cellular network, or a location-based services network.

25. The retail system of claim 22, wherein the retail signal comprises at least one of the following: a coupon, a rebate, an advertisement, an offer, a deal, a name of a vendor, a location of the vendor, an inventory of the vendor, an electronic purchase order, or an electronic payment.

26. The retail system of claim 22, wherein the retail signal is configured to be displayed by at least one of the electronic smoking device, the point-of-sale device, or the smart phone.

27. The retail system of claim 26, wherein the retail signal is configured to be displayed via visual, auditory, olfactory, or haptic means.

28. The retail system of claim 22, wherein the vendor program configured to store or exchange data with at least one of the electronic smoking device, the point-of-sale device, the smart phone, or the communication network.

29. The retail system of claim 22, wherein the vendor program is configured to provide the retail signal to at least one of the electronic smoking device, the point-of-sale device, or the smart phone.

30. The retail system of claim 22, wherein the vendor program comprises a computer program or a smart phone application.

31. A method of retailing an electronic smoking dance, the method comprising:
collecting at least one of the following types of data: i) electronic-smoking device data received from the electronic smoking device, ii) pack data received from a charging pack configured to hold or charge the electronic smoking device, iii) point-of-sale data received from a point-of-sale device configured to facilitate sales of at least one of the charging pack or the electronic smoking device, or iv) smart-phone data received from a smart phone configured to communicate with at least one of the pack or the point-of-sales device;
selecting a retail signal based on the collected data; and
displaying the retail signal on at least one of the electronic smoking device, the charging pack, the point-of-sale device, the smart phone, or a vendor program.

32. The method of claim 31, wherein collecting the data comprises using a communication network to receive or store the data, the communication network being configured to communicatively link at least one of the electronic smoking device, the charging pack, the point-of-sale device, the smart phone, and a vendor.

33. The method of claim 32, wherein collecting the data further comprises using a radio frequency beacon located within at least one of the electronic smoking device, the charging pack, or the point-of-sale device; and wherein the radio frequency beacon is configured to trigger an exchange of data between at least one of the electronic smoking device, the charging pack, the point-of-sale device, the smart phone, the communication network, or the vendor.

34. The method of claim 31, wherein selecting the retail signal comprises selecting at least one of the following: a coupon, a rebate, an advertisement, an offer, as deal, a name of a vendor, a location of the vendor, an inventory of the vendor, an electronic purchase order, or an electronic payment.

35. The method of claim 31, wherein displaying, the retail signal comprises displaying at least one of a visual, auditory, olfactory, or haptic signal.

36. The method of claim 31, further comprising using the vendor program to store or exchange the collected data with at least one of the electronic smoking device, the charging pack, the point-of-sale device, the smart phone, the communication network, or the vendor program.
